(19) United States
(12) Patent Application Publication
(10) Pub. No.: US 2026/0133669 A1
(43) Pub. Date: May 14, 2026

(54) EMOJI PROCESSING METHOD, APPARATUS, ELECTRONIC DEVICE AND STORAGE MEDIA

(71) Applicant: Beijing Zitiao Network Technology Co., Ltd., Beijing (CN)

(72) Inventors: Jie YU, Beijing (CN); Junchen LI, Beijing (CN)

(21) Appl. No.: 18/705,491

(22) PCT Filed: Nov. 8, 2022
(86) PCT No.: PCT/CN2022/130591

§ 371 Date: Apr. 26, 2024

(30) Foreign Application Priority Data
Nov. 15, 2021 (CN) 202111350340.3

(51) Int. Cl. G06F 3/04817; G06F 3/0482; G06F 3/0484

(52) U.S. Cl. CPC G06F 3/04817; G06F 3/0482; G06F 3/0484

(57) ABSTRACT

The present disclosure relates to an emoji processing method, an apparatus, an electronic device and a storage media. The emoji processing method includes receiving an evocation operation on an emoji panel in a current service scenario; and displaying the emoji panel in response to the evocation operation on the emoji panel, wherein the emoji panel comprises personalized emoji(s) related to the current service scenario.

### CROSS-REFERENCE TO RELATED APPLICATIONS

The present disclosure is a U.S. National Stage Application under 35 U.S.C. § 371 of International Patent Application No. PCT/CN2022/130591, filed on Nov. 8, 2022, which is based on and claims priority of Chinese application for invention No. 202111350340.3, filed on Nov. 15, 2021, the disclosures of which are hereby incorporated into this disclosure by reference in their entireties.

### TECHNICAL FIELD

This disclosure relates to the field of computer technology, particularly to an emoji processing method, an apparatus, an electronic device and a storage media.

### BACKGROUND

In some applications, users can communicate using emojis provided in an emoji panel, or insert text-related emojis in text content when editing documents to enhance application scenarios.

Some applications in related technologies can display fixed emojis to users, and users can only use those fixed emojis already available in an emoji panel.

### SUMMARY

In a first aspect, the present disclosure provides an emoji processing method applied to a service system comprising a plurality of different service scenarios, the method comprising:
receiving an evocation operation on an emoji panel in a current service scenario; and
displaying the emoji panel in response to the evocation operation on the emoji panel, wherein the emoji panel comprises the personalized emoji(s) related to the current service scenario.

In a second aspect, the present disclosure provides an emoji processing apparatus, comprising:
a receiving module for receiving an evocation operation on an emoji panel in a current service scenario; and
a display module for displaying an emoji panel in response to the evocation operation on the emoji panel, wherein the emoji panel includes personalized emojis related to the current service scenario.

In a third aspect, the present disclosure provides an electronic device, comprising: a memory and a processor; wherein the memory is used for storing program instructions; the processor is used to evoke the program instructions in the memory to cause the electronic device to implement the emoji processing method in the first aspect and any possible design of the first aspect.

In a fourth aspect, the present disclosure provides a non-transitory computer storage medium including computer instructions that, when executed on an electronic device, cause the electronic device to implement the emoji processing method in the first aspect and any possible design of the first aspect.

In a fifth aspect, the present disclosure provides a non-transitory computer program product that, when executed on a computer, causes the computer to implement the emoji processing method in the first aspect and any possible design of the first aspect.

### BRIEF DESCRIPTION OF THE DRAWINGS

Herein, the accompanying drawings, which are incorporated in and constitute a part of this specification, illustrate embodiments of the present disclosure and, together with the description, serve to explain the principles of the present disclosure.

In order to more clearly explain the embodiments of the present invention or the technical solutions in the prior art, a brief introduction will be given below for the drawings required to be used in the description of the embodiments or the prior art. It is obvious that, for a person skilled in the art, he or she may also acquire other drawings according to such drawings on the premise that no inventive effort is involved.

FIG. 1 is a flowchart of an emoji processing method provided in this disclosure;

FIGS. 2A to 2J are schematic diagrams of interaction interfaces provided by embodiments of this disclosure;

FIG. 3 is a structural diagram of an emoji processing apparatus provided by an embodiment of this disclosure.

### DETAILED DESCRIPTION

In order to better understand the above objects, features and advantages of the present disclosure, the scheme of the present disclosure will be further described below. It should be noted that, in the case of no conflict, the embodiments and the features of the embodiments of the present disclosure may be combined with each other.

Many specific details are set forth in the following description to facilitate a full understanding of the present disclosure, but the present disclosure can also be implemented in other ways different from those described herein. Obviously, embodiments described in the description are only some embodiments of the present disclosure, and are not all of embodiments thereof.

Exemplarily, the present disclosure provides an emoji processing method and apparatus, an electronic device, a storage medium and a product, the method comprising receiving an evocation operation on an emoji panel performed by a user in a current service scenario and, in response to that operation, displaying an emoji panel corresponding to the current service scenario on a display interface of the application, wherein a set of personalized emojis related to the current service scenario are displayed in the emoji panel corresponding to the current service scenario. Therefore, the application scenarios of emojis can be expanded by configuring personalized emojis that are highly relevant to each of different service scenarios in an emoji panel used for that service scenario, allowing users to accurately express their current status with relevant emojis in a current service scenario, and thereby effectively improving user stickiness.

The emoji processing method of the present disclosure is performed by an electronic device or an application in an electronic device, or performed on a web page or an official account, etc. The electronic device can include a mobile phone, a tablet computer, a wearable electronic device, an on-board device, an augmented reality (AR)/virtual reality (VR) device, a notebook computer, an ultra mobile personal computer (UMPC), a netbook, a personal digital assistant (PDA), and smart home equipment such as a smart TV, a smart screen, a HDTV, a 4K TV, a smart speaker, and a smart projector. The present disclosure is not limited to any specific type of the electronic device.

The type of the operating system of the electronic device is not limited in the present disclosure. For example, it may be Android, Linux, Windows, IOS, etc.

Some applications in related technologies can display fixed emojis to users, and users can only use those fixed emojis already available in an emoji panel. This can lead to a decrease in user stickiness.

In order to address the above technical problem, the present disclosure provides an emoji processing method and apparatus, an electronic device, a storage medium and a product.

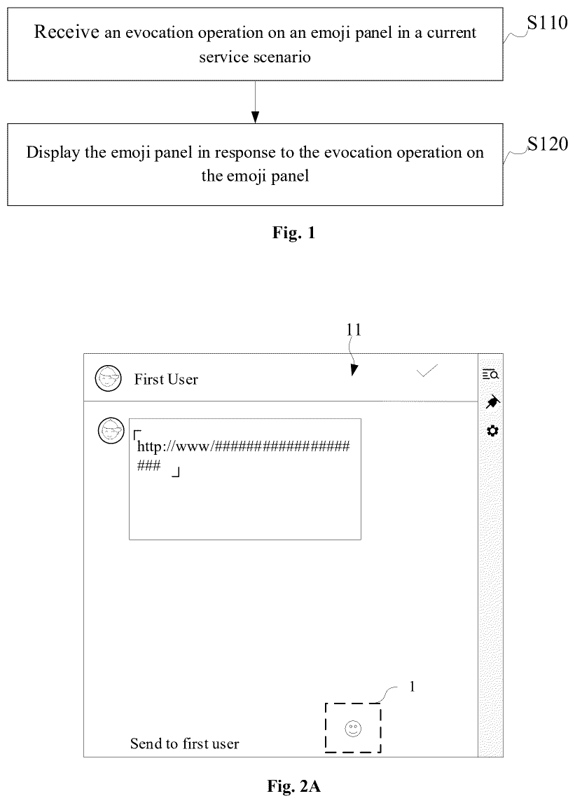

Referring to FIG. 1, FIG. 1 is a flowchart of an emoji processing method provided in an embodiment of the present disclosure. As shown in FIG. 1, the emoji processing method provided by the present disclosure may comprise the following steps.

In step S110, an evocation operation on an emoji panel is received in a current service scenario.

When a user launches an application in an electronic device, the application will display its application interface to the user on the electronic device. The application interface displayed to the user includes a plurality of function windows related to a current service scenario of the application, such as a text input window, an emoji display window, etc. Each function window may correspond to an evocation interface. The current service scenarios can include a service scenario of cloud document, a service scenario of video conference, etc.

A user can perform an evocation operation to evoke a function window on an evocation interface corresponding to that function window.

The user's evocation operation on the emoji panel can be achieved in a variety of ways, such as by triggering a virtual button corresponding to an emoji panel in the current service scenario to accomplish the evocation operation on the emoji panel.

Optionally, receiving the evocation operation on the emoji panel in the current service scenario comprises:
receiving a trigger operation on an emoji button for evoking the emoji panel in the current service scenario.

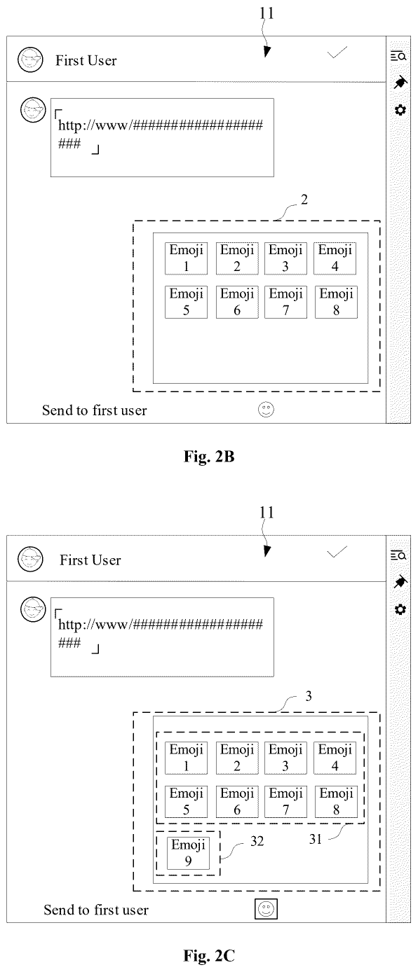

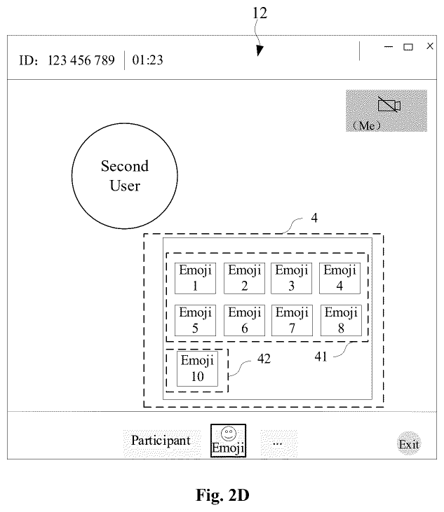

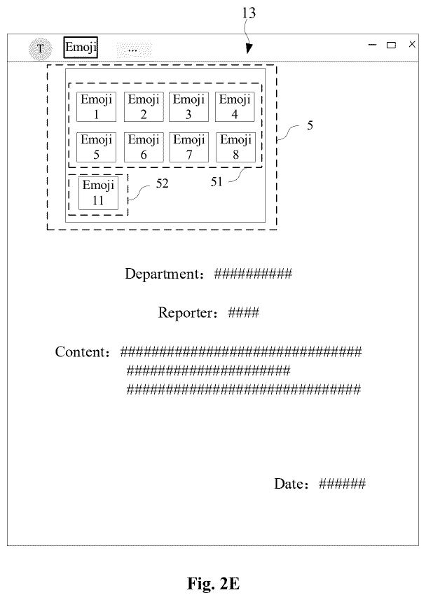

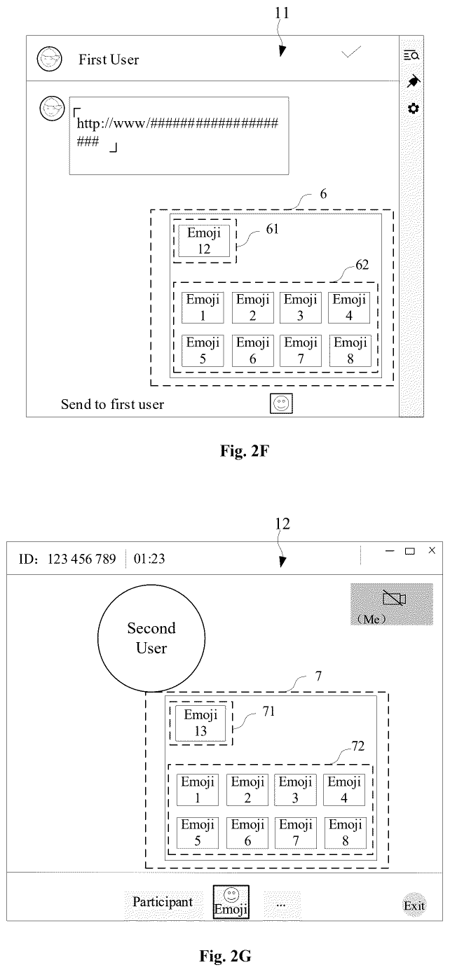

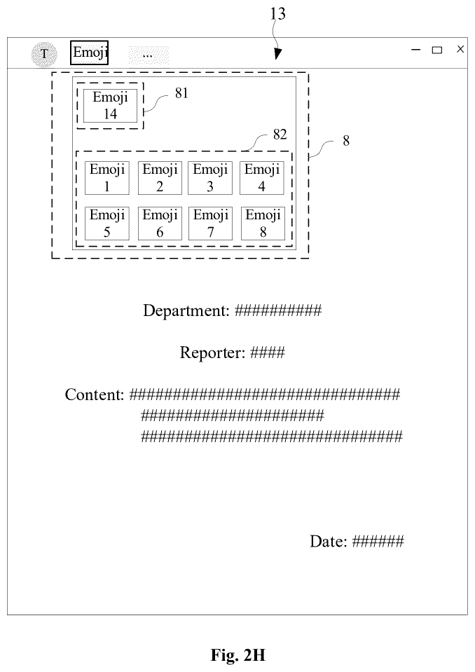

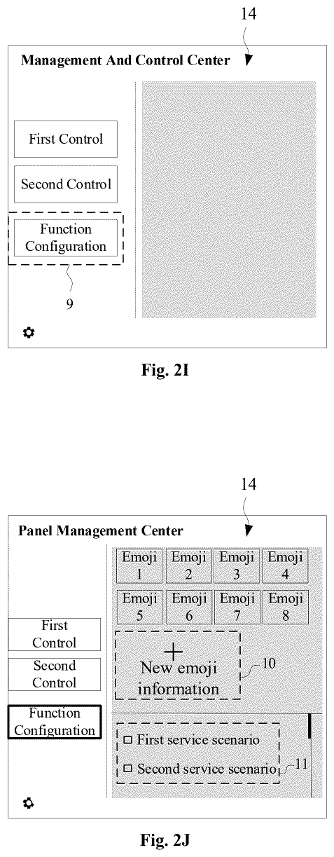

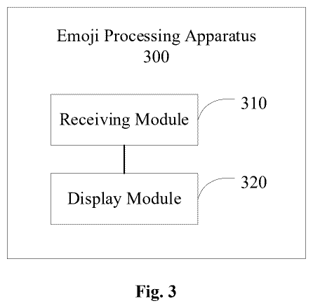

In a case where the user is in a current service scenario, the application will display a service interface corresponding to the current service scenario for use by the user. The service interface corresponding to the current service scenario can at least include an emoji button corresponding to an emoji panel, and the user can click on the emoji button to evoke the emoji panel. As an example, FIG. 2A shows a particular emoji button in a region 1 of an interface 11.

The click operation can include single-click, double-click, etc., which is not specifically limited in the present disclosure.

Thus, it is convenient for users to use a preset emoji button to evoke the display of an emoji panel corresponding to the emoji button, enabling an electronic device to recognize the need to evoke the emoji panel based on a trigger operation on the emoji button.

In step S120, the emoji panel is displayed in response to the evocation operation on the emoji panel, wherein the emoji panel comprises personalized emoji(s) related to the current service scenario.

The application is provided with different emoji panels according to different service scenarios to meet the requirements for emojis in different service scenarios. As an example, FIG. 2B shows a particular emoji panel corresponding to a current service scenario in a region 2 of the interface 11.

In this embodiment of the present disclosure, a user's evocation operation on an emoji panel can be received in a current service scenario and, in response to the operation, the emoji panel corresponding to the current service scenario is displayed on a display interface of the application, wherein a set of personalized emojis related to the current service scenario are displayed in the emoji panel corresponding to the current service scenario. Therefore, the application scenarios of emojis can be expanded by configuring personalized emojis that are highly relevant to each of different service scenarios in an emoji panel used for that service scenario, allowing users to accurately express their current status with relevant emojis in a current service scenario, and thereby effectively improving user stickiness.

The service scenarios can include a chat scenario, a conference scenario (such as a service scenario of video conference), or a document scenario (such as a service scenario of cloud document), etc., which are not specifically limited in the present disclosure.

The emoji panel includes personalized emojis related to the current service scenario.

The personalized emojis can be presented as emoji animations, emoji symbols, emoji images, etc.

In some embodiments, the personalized emojis may include non-duplicated emoji animations for display; or the personalized emojis may include non-duplicated emoji symbols for display; or the personalized emojis may include non-duplicated emoji images for display.

In other embodiments, the personalized emojis may include non-duplicated emoji animations and non-duplicated emoji symbols for display; or the personalized emojis may include non-duplicated emoji symbols and non-duplicated emoji images for display; or the personalized emojis may include non-duplicated emoji animations and non-duplicated emoji images for display.

In still other embodiments, the personalized emojis may include non-duplicated emoji animations, non-duplicated emoji symbols, and non-duplicated emoji images for display.

It should be noted that the emojis included in the emoji panels corresponding to different service scenarios can have duplicated (i.e. the same) expression meanings, or different emojis may correspond to independent (i.e. different) expression meanings in different service scenarios, or the same emoji can correspond to independent expression meanings in different service scenarios.

For example, an emoji panel corresponding to the chat scenario includes 30 emojis, an emoji panel corresponding to the conference scenario includes 40 emojis, and an emoji panel corresponding to the document scenario includes 35 emojis.

In the above example, for the situation that the emojis included in the emoji panels corresponding to different service scenarios can have duplicated meanings, there may be 20 emojis that are the same among the 30 emojis included in the emoji panel corresponding to the chat scenario, the 40 emojis included in the emoji panel corresponding to the conference scenario, and the 35 emojis included in the emoji panel corresponding to the document scenario, and different emojis may correspond to the same expression meanings in these three service scenarios.

That is to say, in a case where the emojis are displayed in the form of emoji animations, and the emoji panels corresponding to the chat scenario, the conference scenario, and the document scenario include 20 identical emoji animations, then each identical emoji animation represents the same expression meaning in the three service scenarios. For example, in a case where an emoji animation A represents “Doubt” in the chat scenario, then this emoji animation A can also represent “Doubt” in the conference and document scenarios.

For the situation that different emojis may correspond to independent expression meanings in different service scenarios, there may be 10 different emojis among the 30 emojis included in the emoji panel corresponding to the chat scenario, the 40 emojis included in the emoji panel corresponding to the conference scenario, and the 35 emojis included in the emoji panel corresponding to the document scenario, and these different emojis may correspond to the different expression meanings in these three service scenarios.

That is to say, in a case where the emojis are displayed in the form of emoji animations, in the emoji panels corresponding to the chat scenario, the conference scenario, and the document scenario, 10 emoji animations in the chat scenario are distinct from the emoji animations in the emoji panels corresponding to the conference scenario and the document scenario respectively, and these 10 emoji animations have different expression meanings in these three service scenarios respectively.

For the situation that the same emoji can correspond to independent expression meanings in different service scenarios, there may be 10 identical emojis among the 30 emojis included in the emoji panel corresponding to the chat scenario, the 40 emojis included in the emoji panel corresponding to the conference scenario, and the 35 emojis included in the emoji panel corresponding to the document scenario, and these different emojis may correspond to the different expression meanings in these three service scenarios.

That is to say, in a case where the emojis are displayed in the form of emoji animations, in the emoji panels corresponding to the chat scenario, the conference scenario, and the document scenario, 10 emoji animations in the chat scenario also exit in those emoji animations in the emoji panels corresponding to the conference scenario and the document scenario respectively, and these 10 emoji animations have different expression meanings in these three service scenarios respectively. For example, emoji animation B may appear simultaneously in the emoji panel corresponding to the chat scenario, the emoji panel corresponding to the conference scenario, and the emoji panel corresponding to the document scenario. However, it has a “helplessness” meaning in the chat scenario, a “Confused/Puzzled/Do not understand” meaning in the conference scenario, and a “Depressed” meaning in the document scenario.

Based on the description of the above embodiment, the application needs to determine an emoji panel corresponding to the current service scenario before displaying it in response to the evocation operation on the emoji panel, and then evoke the emoji panel to display it in the interface.

Optionally, this embodiment may further comprise:
determining the current service scenario; and
determining the emoji panel corresponding to the current service scenario based on the current service scenario.

The current service scenario can be determined based on entry information of the emoji button. Different service scenarios correspond to emoji buttons with different entry information. For example, the entry information may include a position or an identifier of the emoji button in the service scenario, etc.

As an example, the entry information of the emoji button is the position of the emoji

### Button in the Service Scenario.

In some embodiments, in a case where the service scenario is a chat scenario, the entry information of the emoji button can be disposed at a preset position on a chat interface, or at a certain position within a text input box on the chat interface, or at a certain position outside the text input box on the chat interface.

For example, the entry information of the emoji button can be disposed in an upper area, a lower area, a left area, or a right area of the chat interface; or the entrance information of the emoji button can be disposed at the top or bottom of the chat interface. This disclosure does not have specific limitations on the location of the entry information of the emoji button.

In other embodiments, in a case where the service scenario is a conference scenario, the entry information of the emoji button can be disposed at a preset position on a conference interface, or at a certain position within a text input box on the conference interface, or at a certain position outside the text input box on the conference interface.

For example, the entry information of the emoji button can be disposed in an upper area, a lower area, a left area, or a right area of the conference interface; or the entrance information of the emoji button can be disposed at the top or bottom of the conference interface. This disclosure does not have specific limitations on the position of the entry information of the emoji button.

In still other embodiments, in a case where the service scenario is a document scenario, the entry information of the emoji button can be disposed at a preset position on a document interface, or at a certain position within a text input box on the document interface, or at a certain position outside the text input box on the document interface.

For example, the entry information of the emoji button can be disposed in an upper area, a lower area, a left area, or a right area of the document interface; or the entrance information of the emoji button can be disposed at the top or bottom of the document interface. This disclosure does not have specific limitations on the position of the entry information of the emoji button.

As an example, the entry information of the emoji button is an identifier corresponding

### To the Service Scenario.

In some embodiments, in a case where the service scenario is a chat scenario, the identifier corresponding to the entry information of the emoji button can be displayed as a character A1, or the identifier corresponding to the entry information of the emoji button can be displayed as an image A2, or the identifier corresponding to the entry information of the emoji button can be displayed as text A3.

In some embodiments, in a case where the service scenario is a conference scenario, the identifier corresponding to the entry information of the emoji button can be displayed as a character B1, or the identifier corresponding to the entry information of the emoji button can be displayed as an image B2, or the identifier corresponding to the entry information of the emoji button can be displayed as text B3.

In still other embodiments, in a case where the service scenario is a document scenario, the identifier corresponding to the entry information of the emoji button can be displayed as a character C1, or the identifier corresponding to the entry information of the emoji button can be displayed as an image C2, or the identifier corresponding to the entry information of the emoji button can be displayed as text C3.

Note that characters A1, B1 and C1 can be similar characters with some correlation, images A2, B2 and C2 can be similar images with some correlation, and text A3, B3 and C3 can be similar text with some correlation.

The entry information of the emoji button corresponding to each service scenario is different. Based on the entry information of the emoji button, the current service scenario can be quickly identified, and an emoji panel corresponding to the current service scenario can be called up for display to determine the emoji panel suitable for the current service scenario.

Based on the above examples, an example will be given, in which the entry information of the emoji button is its position to determine an emoji panel corresponding to the current service scenario.

In some embodiments, in a case where the electronic device detects that the entry information of the emoji button is its position in a right area of a chat interface, the current service scenario is determined as a chat scenario based on the entry information of the emoji button. Based on the current service scenario, an emoji panel corresponding to the current service scenario is determined as an emoji panel corresponding to the chat scenario.

In other embodiments, in a case where the electronic device detects that the entry information of the emoji button is its position in a right area of a conference interface, the current service scenario is determined as a conference scenario based on the entry information of the emoji button. Based on the current service scenario, an emoji panel corresponding to the current service scenario is determined as an emoji panel corresponding to the conference scenario.

In still other embodiments, in a case where the electronic device detects that the entry information of the emoji button is its position in a right area of a document interface, the current service scenario is determined as a document scenario based on the entry information of the emoji button. Based on the current service scenario, an emoji panel corresponding to the current service scenario is determined as an emoji panel corresponding to the document scenario.

Based on the above examples, an example will be given, in which the entry information of the emoji button is its identification character(s) to determine an emoji panel corresponding to the current service scenario.

In some embodiments, in a case where the electronic device detects that the entry information of the emoji button is an identifier “character A1/image A2/text A3”, the current service scenario is determined as a chat scenario based on the entry information of the emoji button. Based on the current service scenario, an emoji panel corresponding to the current service scenario is determined as an emoji panel corresponding to the chat scenario.

In other embodiments, in a case where the electronic device detects that the entry information of the emoji button is an identifier “character B1/image B2/text B3”, the current service scenario is determined as a conference scenario based on the entry information of the emoji button. Based on the current service scenario, an emoji panel corresponding to the current service scenario is determined as an emoji panel corresponding to the conference scenario.

In still other embodiments, in a case where the electronic device detects that the entry information of the emoji button is an identifier “character C1/image C2/text C3”, the current service scenario is determined as a document scenario based on the entry information of the emoji button. Based on the current service scenario, an emoji panel corresponding to the current service scenario is determined as an emoji panel corresponding to the document scenario.

Based on the description of the above embodiments, the application supports administrator-customized emojis in an emoji panel. An administrator can manage the emojis in the emoji panel for all users in his organization, and can update and configure the emojis in the emoji panel for all users through manual settings in a management control center of emoji panels.

For example, custom emojis in an emoji panel can be partially deleted or modified for all user; or custom emojis in the emoji panel can be fully deleted or modified for all users.

Optionally, the method of this embodiment may further comprise:
receiving a custom emoji uploaded by the administrator; and
updating emoji panels corresponding to all users within an organization to which the administrator belongs based on the custom emoji and the organization n.

The custom emoji uploaded by the administrator can be implemented through a custom setting, and can be presented as an emoji character, an emoji image, or an emoji animation, etc.

Specifically, the emoji panel area can be designed as a universal component in the application, and a container area can be reserved in the emoji panel area for the administrator to upload emojis to be displayed within that container area.

The container area also allows the administrator to flexibly configure the position, size and order of each custom emoji.

As a result, new personalized emojis can be added based on the preservation of inherent emojis included in a traditional emoji panel, making it easier for users to experience the use of more emojis in their organization.

Custom emojis can be divided into different service scenarios to enable the electronic device to update an emoji panel for users based on the service scenario an emoji belongs to. Here are examples of updating emojis in different service scenarios.

An emoji panel can include a first region and a second region, wherein the first and second regions can be used to display different emojis respectively.

In some embodiments, the first region is located above the second region, and may be used to display emojis that are common to various service scenarios. The second region may be used to display personalized emojis related to the current service scenario.

Taking an example where the service scenario is a chat scenario, assuming that a custom emoji uploaded by the administrator is one emoji, such as emoji 9, FIG. 2B shows an emoji panel of emoji panels corresponding to all users within the organization before the update in region 2, and FIG. 2C shows an emoji panel of emoji panels corresponding to all users within the organization after the update in region 3.

The region 3 can include a first region (such as a region 31) and a second region (such as a region 32). Emojis 1 to 8 in the region 31 are official emojis that are common to various service scenarios and do not support user modification. Emoji 9 in the region 32 is a custom emoji uploaded by the administrator.

Taking an example where the service scenario is a conference scenario, assuming that a custom emoji uploaded by the administrator is an emoji, such as emoji 10, FIG. 2D shows an emoji panel of emoji panels corresponding to all users within the organization after the update in a region 4 of an interface 12.

The region 4 can include a first region (such as a region 41) and a second region (such as a region 42). Emojis 1 to 8 in the region 41 are official emojis that are common to various service scenarios and do not support user modification. Emoji 10 in the region 42 is a custom emoji uploaded by the administrator.

Taking an example where the service scenario is a document scenario, assuming that a custom emoji uploaded by the administrator is one emoji, such as emoji 11, FIG. 2E shows an emoji panel of emoji panels corresponding to all users within the organization after the update in a region 5 of an interface 13.

The region 5 can include a first region (such as a region 51) and a second region (such as a region 52). Emojis 1 to 8 in the region 51 are official emojis that are common to various service scenarios and do not support user modification. Emoji 11 in the region 52 is a custom emoji uploaded by the administrator.

In other embodiments, the first region can be used to display personalized emojis related to the current service scenario, the second region can be used to display emojis that are common to various service scenarios, and the first region can be located above the second region, thereby facilitating users to quickly view custom emojis when entering the current service scenario.

Taking an example where the service scenario is a chat scenario, assuming that a custom emoji uploaded by the administrator is one emoji, such as emoji 12, FIG. 2B shows an emoji panel of emoji panels corresponding to all users within the organization before the update in region 2, and FIG. 2F shows an emoji panel of emoji panels corresponding to all users within the organization after the update in region 6.

The region 6 can include a first region (such as a region 61) and a second region (such as a region 62). The emoji 12 in the region 61 is a custom emoji uploaded by the administrator, and emojis 1-8 in the region 62 are official emojis that are common to various service scenarios and do not support user modification.

Taking an example where the service scenario is a conference scenario, assuming that a custom emoji uploaded by the administrator is one emoji, such as emoji 13, FIG. 2G shows an emoji panel of emoji panels corresponding to all users within the organization after the update in a region 7 of an interface 12.

The region 7 can include a first region (such as a region 71) and a second region (such as a region 72). The emoji 13 in the region 71 is a custom emoji uploaded by the administrator, and emojis 1-8 in the region 72 are official emojis that are common to various service scenarios and do not support user modification.

Taking an example where the service scenario is a document scenario, assuming that a custom emoji uploaded by the administrator is one emoji, such as emoji 14, FIG. 2H shows an emoji panel of emoji panels corresponding to all users within the organization after the update in a region 8 of an interface 13.

The region 8 can include a first region (such as a region 81) and a second region (such as a region 82). The emoji 14 in the region 81 is a custom emoji uploaded by the administrator, and emojis 1-8 in the region 82 are official emojis that are common to various service scenarios and do not support user modification.

In addition, the administrator can upload a plurality of custom emojis, and specify the position, size, or order of the plurality of custom emojis.

Optionally, before the updating the emoji panel corresponding to the all users within the organization to which the administrator belongs based on the custom emoji and the organization, the method of this embodiment may further comprise:
obtaining target application scenario(s) for the custom emoji.

Furthermore, the step of the updating the emoji panel corresponding to the all users within the organization to which the administrator belongs based on the custom emoji and the organization may comprise:
updating the emoji panel corresponding to the target application scenario(s) of the all users within the organization to which the administrator belongs based on the custom emoji and the organization.

Based on the target application scenario(s) the custom emoji belongs to, the electronic device can update an emoji panel corresponding to the target application scenario(s), making it easier for users to experience the use of more emojis in the target application scenario within their organization.

The custom emoji can include: “Can you hear it”, “The document is written well”, “You look so cute”, and so on.

Taking a custom emoji “Can you hear it” as an example, in some embodiments, in a case where the custom emoji is “Can you hear it”, when it is determined that the target application scenario corresponding to this custom emoji is a chat scenario, based on this custom emoji and an organization to which an administrator belongs, an emoji panel corresponding to the chat scenario is updated for all users within the organization.

In other embodiments, in the case where the custom emoji is “Can you hear it”, when it is determined that the target application scenario corresponding to this custom emoji is a conference scenario, based on this custom emoji and an organization to which an administrator belongs, an emoji panel corresponding to the conference scenario is updated for all users within the organization.

Taking a custom emoji “The document is written well” as an example, in some embodiments, in a case where the custom emoji is “The document is written well”, when it is determined that the target application scenario corresponding to this custom emoji is a document scenario, based on this custom emoji and an organization to which an administrator belongs, an emoji panel corresponding to the document scenario is updated for all users within the organization.

In other embodiments, in a case where the custom emoji is “The document is written well”, when it is determined that the target application scenario corresponding to this custom emoji is a conference scenario, based on this custom emoji and an organization to which an administrator belongs, an emoji panel corresponding to the conference scenario is updated for all users within the organization.

Taking a custom emoji “You look so cute” as an example, in some embodiments, in a case where the custom emoji is “You look so cute”, when it is determined that the target application scenario corresponding to this custom emoji is a chat scenario, based on this custom emoji and an organization to which an administrator belongs, an emoji panel corresponding to the chat scenario is updated for all users within the organization.

The target application scenario can be obtained for the custom emoji in following manners.

In some embodiments, obtaining a target application scenario for a custom emoji comprises: receiving the target application scenario(s) selected by the administrator for the custom emoji, wherein the target application scenario(s) comprises one or more service scenarios.

When an administrator sets a custom emoji, specific application scenario(s) can be specified as the target application scenario(s) corresponding to the custom emoji, facilitating the customization of emojis used in different service scenarios within an organization by different service parties.

Taking a custom emoji “Can you hear it” as an example, in an example, after an administrator determines that the custom emoji is “Can you hear it”, the administrator can specify that a target application scenario corresponding to this custom emoji is a conference scenario, and then the electronic device can identify that the target application scenario of this custom emoji is a conference scenario.

In another example, after the administrator determines that the custom emoji is “Can you hear it”, the administrator can specify that a target application scenario corresponding to this custom emoji includes a conference scenario and a chat scenario, and then the electronic device can identify that the target application scenario of this custom emoji includes a conference scenario and a chat scenario.

In other embodiments, the obtaining a target application scenario for a custom emoji comprises: determining the target application scenario(s) matched with the custom emoji.

Taking a custom emoji “Can you hear it” as an example, in an example, after receiving a custom emoji “Can you hear it” uploaded by an administrator, the electronic device configures a target application scenario for the custom emoji based on service scenarios in which the custom emoji can be used. For example, in the chat scenario, “Can you hear it” can be used to ask the receiver if he or she has heard the voice message sent by the sender, so the corresponding target service scenario can be configured to be a chat scenario.

In another example, after receiving a custom emoji “Can you hear it” uploaded by an administrator, the electronic device configures a target application scenario for the custom emoji based on service scenarios in which the custom emoji can be used. For example, in the chat scenario, “Can you hear it” can be used to ask the receiver if he or she has heard the voice message sent by the sender. In addition, in the conference scenario, “Can you hear it” can be used to ask a participant if he or she has heard the voice of the speaker, so the corresponding target service scenario can be configured to include a chat scenario and a conference scenario.

Thus, the electronic device can automatically match a corresponding target application scenario based on the custom emoji, and select service scenarios with a higher degree of match for each custom emoji as the target service scenario to expand the application scenarios of the custom emoji.

Before receiving the target application scenario(s) selected by the administrator for the custom emoji, the method may further comprise:
displaying an emoji configuration panel that displays an emoji upload entry and at least one service scenario option in response to the administrator triggering an emoji configuration control.

An administrator can click to trigger the emoji configuration control displayed in the display interface of the management control center of emoji panels. FIG. 2I shows an interface 14 as an example of the display interface of the management control center. As an example of the emoji configuration control, a function configuration control that can be triggered is displayed in a region 9 of the interface 14.

After receiving a trigger operation on the function configuration control displayed in the interface 14, a display interface of the emoji configuration panel is displayed as show in the interface 14 of FIG. 2J.

In the interface 14, an emoji upload entry is displayed on the emoji configuration panel as shown in the region 10 of FIG. 2J, and at least one service scenario option can be displayed, for example, the first and second service scenarios in the region 11 of FIG. 2J. The regions corresponding to the first and second service scenarios are can be selected and triggered.

The application can display an emoji configuration panel that presents an emoji upload entry and at least one service scenario option.

The administrator can upload a custom emoji via the emoji upload entry displayed on the emoji configuration panel. The service scenario option(s) allows the administrator to customize the target service scenario for the uploaded custom emoji.

Note that in addition to the service scenario option(s), the emoji configuration panel can also include an input window, allowing the administrator to input a service scenario to be specified for the custom emoji in the input window.

The trigger operation can include: a single click, a double click, etc., which is not specifically limited in the present disclosure.

Thus, by means of the provided emoji configuration control, after receiving a trigger operation performed by an administrator on the emoji configuration control, the emoji configuration panel is displayed, allowing the administrator to customize the emoji to be uploaded and the corresponding service scenario on the emoji configuration panel.

FIG. 3 is a schematic structure diagram of an emoji processing apparatus provided in the present disclosure. As shown in FIG. 3, the emoji processing apparatus 300 of the present disclosure comprises a receiving module 310 and a display module 320, wherein:
the receiving module 310 is used for receiving an evocation operation on an emoji panel in a current service scenario;
the display module 320 is used for displaying the emoji panel in response to the evocation operation on the emoji panel, wherein the emoji panel comprises personalized emoji(s) related to the current service scenario.

In this embodiment, optionally, the emoji panel comprises a first region for displaying personalized emoji(s) related to the current service scenario, and a second region for displaying emoji(s) common to various service scenarios.

In this embodiment, optionally, the receiving module 310 is specifically used for:
receiving a trigger operation on an emoji button for evoking the emoji panel in the current service scenario.

In this embodiment, optionally, the apparatus further comprises: a first determination module and a second determination module;
the first determination module is used for determining the current service scenario;
the second determination module is used for determining the emoji panel corresponding to the current service scenario based on the current service scenario.

In this embodiment, optionally, the current service scenario is: at least one of a service scenario of cloud document or a service scenario of video conference.

In this embodiment, optionally, the apparatus further comprises: an update module;
the receiving module 310 is further used for receiving a custom emoji uploaded by an administrator;
the update module is used for updating an emoji panel of emoji panels corresponding to all users within an organization to which the administrator belongs based on the custom emoji and the organization.

In this embodiment, optionally, the apparatus further comprises: an obtaining module;

The obtaining module is used for obtaining target application scenario(s) for the custom emoji;
the update module is particularly used for updating the emoji panel corresponding to the target application scenario(s) of the all users within the organization to which the administrator belongs based on the custom emoji and the organization.

In this embodiment, optionally, the obtaining module is particularly used for:
receiving the target application scenario(s) selected by the administrator for the custom emoji, wherein the target application scenario(s) comprises one or more service scenarios; or
determining the target application scenario(s) matched with the custom emoji.

In this embodiment, optionally, the display module 320 is further used for displaying an emoji configuration panel that displays an emoji upload entry and at least one service scenario option in response to the administrator triggering an emoji configuration control.

The emoji processing apparatus provided by the present disclosure can implement the above method embodiment. For its specific implementation principles and technical effect, reference can be made to the above method embodiment, which will not be repeated herein.

Exemplarily, the present disclosure provides an electronic device, comprising: a processor for executing a computer program stored in memory, wherein the computer program, when executed by the processor, implements the steps of any method embodiment described above.

Exemplarily, the present disclosure provides a non-transitory computer-readable storage medium having stored thereon a computer program that, when executed by a processor, implement the steps of any method embodiment described above.

Exemplarily, the present disclosure provides a non-transitory computer program product that, when running on a computer, causes the computer to implement the steps of any method embodiment described above.

In a first aspect, the present disclosure provides an emoji processing method, comprising:
receiving an evocation operation on an emoji panel in a current service scenario; and
displaying the emoji panel in response to the evocation operation on the emoji panel, wherein the emoji panel comprises personalized emoji(s) related to the current service scenario.

Optionally, the emoji panel comprises a first region and a second region, wherein the first region is used to display personalized emojis related to the current service scenario, and the second region is used to display emojis common to various service scenarios.

Optionally, the receiving the evocation operation on the emoji panel in the current service scenario comprises:
receiving a trigger operation on an emoji button for evoking the emoji panel in the current service scenario.

Optionally, before displaying the emoji panel in response to the evocation operation on the emoji panel, the method further comprises:
determining the current service scenario;
determining the emoji panel corresponding to the current service scenario based on the current service scenario.

Optionally, the current service scenario is: a service scenario of cloud document and/or a service scenario of video conference.

Optionally, the method further comprises:
receiving a custom emoji uploaded by an administrator; and
updating emoji panels corresponding to all users within an organization to which the administrator belongs based on the custom emoji and the organization.

Optionally, the method further comprises:
obtaining target application scenario(s) for the custom emoji;
the updating the emoji panel corresponding to the all users within the organization to which the administrator belongs based on the custom emoji and the organization comprises:
updating the emoji panel corresponding to the target application scenario(s) of the all users within the organization to which the administrator belongs based on the custom emoji and the organization.

Optionally, obtaining a target application scenario for the custom emoji comprises:
receiving the target application scenario(s) selected by the administrator for the custom emoji, wherein the target application scenario(s) comprises one or more service scenarios; or
determining the target application scenario(s) matched with the custom emoji.

Optionally, before receiving the target application scenario(s) selected by the administrator for the custom emoji, the method further comprises:
displaying an emoji configuration panel that displays an emoji upload entry and at least one service scenario option in response to the administrator triggering an emoji configuration control.

In a second aspect, the present disclosure provides an emoji processing apparatus, comprising:
a receiving module for receiving an evocation operation on an emoji panel in a current service scenario;
a display module for displaying the emoji panel in response to the evocation operation on the emoji panel, wherein the emoji panel comprises personalized emoji(s) related to the current service scenario.

Optionally, the emoji panel comprises a first region for displaying the personalized emoji(s) related to the current service scenario, and a second region for displaying emoji(s) common to various service scenarios.

Optionally, the receiving module is particularly used for:
receiving a trigger operation on an emoji button for evoking the emoji panel in the current service scenario.

In this embodiment, optionally, the apparatus further comprises: a first determination module and a second determination module;
the first determination module is used for determining the current service scenario;
the second determination module is used for determining the emoji panel corresponding to the current service scenario based on the current service scenario.

Optionally, the current service scenario is a service scenario of cloud document or a service scenario of video conference.

Optionally, the apparatus of this embodiment further comprises: an update module;
the receiving module is further used for receiving a custom emoji uploaded by an administrator;
the update module is used for updating, based on the custom emoji and an organization to which the administrator belongs, emoji panels corresponding to all users within the organization.

Optionally, the apparatus of this embodiment further comprises: an obtaining module for obtaining target application scenario(s) for the custom emoji.
the update module is particularly used for updating the emoji panel corresponding to the target application scenario(s) of the all users within the organization to which the administrator belongs based on the custom emoji and the organization.

Optionally, the acquisition module is particularly used for:
receiving the target application scenario(s) selected by the administrator for the custom emoji, wherein the target application scenario(s) comprises one or more service scenarios; or
determining the target application scenario(s) matched with the custom emoji.

Optionally, the display module is further used for displaying an emoji configuration panel that displays an emoji upload entry and at least one service scenario option in response to the administrator triggering an emoji configuration control.

In a third aspect, the present disclosure provides an electronic device, comprising: a processor for executing a computer program stored in memory, wherein the computer program, when executed by the processor, implements the steps of the method described above in the first aspect.

In a fourth aspect, the present disclosure provides a non-transitory computer-readable storage medium having stored thereon a computer program that, when executed by a processor, implement the steps of any method of the first aspect.

In a fifth aspect, the present disclosure provides a non-transitory computer program product that, when running on a computer, causes the computer to implement the steps of any method of the first aspect.

In the above embodiment, all or part of the functions can be realized by software, hardware, or a combination thereof. When implemented in software, it can be implemented in whole or in part in the form of a computer program product. The computer program product includes one or more computer instructions. The computer program instructions, when loaded and executed on a computer, can generate in whole or in part the processes or functions according to embodiments of the present disclosure. The computer may be a general purpose computer, a special purpose computer, a computer network, or other programmable device. The computer instructions may be stored in a computer-readable storage medium. The computer-readable storage medium can be any available medium that can be accessed by a computer or a data storage device such as a server, data center, or the like that contains one or more of the available media integrated therein. The available media may be magnetic media (e.g., floppy disks, hard disks, magnetic tapes), optical media (e.g., DVDs), or semiconductor media (e.g., solid state disks (SSDs)), and the like.

Note that, in this description, the use of relational terms, if any, such as “first” and “second” and the like are used solely to distinguish one from another entity or action without necessarily requiring or implying any actual such relationship or order between such entities or actions. Further, terms “include”, “comprise” or their any other variations are intended to encompass non-exclusive composition, so that a process, method, product or device comprising a series of factors may comprise not only these factors, but also other factors that are not listed explicitly, or factors intrinsic to this process, method, product or device. Without limitation, a factor defined by wording “comprise one . . . ” does not exclude the existence of other same factors in a process, method, product or device comprising such factor.

The above descriptions are only specific embodiments of the present disclosure, so that those skilled in the art can understand or implement the present disclosure. Various modifications to these embodiments will be apparent to those skilled in the art, and the generic principles defined herein may be implemented in other embodiments without departing from the spirit or scope of the present disclosure. Accordingly, the present disclosure should not be limited to the specific embodiments described herein, but should be accorded the broadest scope consistent with the principles and novel features disclosed herein.

1. An emoji processing method applied to a service system comprising a plurality of different service scenarios, the emoji processing method comprising:
receiving an evocation operation on an emoji panel in a current service scenario; and
displaying the emoji panel in response to the evocation operation on the emoji panel, wherein the emoji panel comprises personalized emoji(s) related to the current service scenario.

2. The emoji processing method according to claim 1, wherein the emoji panel comprises a first region for displaying the personalized emoji(s) related to the current service scenario, and a second region for displaying emoji(s) common to various service scenarios.

3. The emoji processing method according to claim 1, wherein the receiving the evocation operation on the emoji panel in the current service scenario comprises:
receiving a trigger operation on an emoji button for evoking the emoji panel in the current service scenario.

4. The emoji processing method according to claim 1, further comprising:
determining the current service scenario before displaying the emoji panel in response to the evocation operation on the emoji panel; and
determining the emoji panel corresponding to the current service scenario based on the current service scenario.

5. The emoji processing method according to claim 4, wherein the determining the current service scenario comprises:
determining the current service scenario based on entry information of an emoji button, wherein the entry information comprises at least one of a position or an identifier of the emoji button in the service scenario.

6. The emoji processing method according to claim 1, wherein the current service scenario is a service scenario of cloud document or a service scenario of video conference.

7. The emoji processing method according to claim 1, further comprising:
receiving a custom emoji uploaded by an administrator; and
updating emoji panels corresponding to all users within an organization to which the administrator belongs based on the custom emoji and the organization.

8. The emoji processing method according to claim 7, wherein:
the emoji processing method further comprises: obtaining target application scenario(s) for the custom emoji; and
the updating the emoji panel corresponding to the all users within the organization to which the administrator belongs based on the custom emoji and the organization comprises: updating the emoji panel corresponding to the target application scenario(s) of the all users within the organization to which the administrator belongs based on the custom emoji and the organization.

9. The emoji processing method according to claim 8, wherein the obtaining the target application scenario(s) for the custom emoji comprises:
receiving the target application scenario(s) selected by the administrator for the custom emoji, wherein the target application scenario(s) comprises one or more service scenarios; or
determining the target application scenario(s) matched with the custom emoji.

10. The emoji processing method according to claim 9, further comprising:
displaying an emoji configuration panel that displays an emoji upload entry and at least one service scenario option in response to the administrator triggering an emoji configuration control before receiving the target application scenario(s) selected by the administrator for the custom emoji.

11. The emoji processing method according to claim 1, wherein
at least part of emojis comprised in emoji panels that correspond to different service scenarios represent the same meanings; or
different emoji(s) represent different meanings in different service scenarios to which the emoji(s) correspond; or
same emoji(s) represents different meanings in different service scenarios to which the emoji(s) correspond.

12. (canceled)

13. An electronic device, comprising:
a processor for executing a computer program stored in memory, wherein the computer program, when executed by the processor, implements the steps of an emoji processing method comprising:
receiving an evocation operation on an emoji panel in a current service scenario; and
displaying the emoji panel in response to the evocation operation on the emoji panel, wherein the emoji panel comprises personalized emoji(s) related to the current service scenario.

14. A non-transitory computer-readable storage medium stored thereon a computer program that, when executed by a processor, implement the steps of an emoji processing method comprising:
receiving an evocation operation on an emoji panel in a current service scenario; and
displaying the emoji panel in response to the evocation operation on the emoji panel, wherein the emoji panel comprises personalized emoji(s) related to the current service scenario.

15. (canceled)

16. The electronic device according to claim 13, wherein the emoji panel comprises a first region for displaying the personalized emoji(s) related to the current service scenario, and a second region for displaying emoji(s) common to various service scenarios.

17. The electronic device according to claim 13, wherein the processor is further configured to:
receive a trigger operation on an emoji button for evoking the emoji panel in the current service scenario.

18. The electronic device according to claim 13, wherein the processor is further configured to:
determine the current service scenario before displaying the emoji panel in response to the evocation operation on the emoji panel; and
determine the emoji panel corresponding to the current service scenario based on the current service scenario.

19. The electronic device according to claim 17, wherein the processor is further configured to:
determine the current service scenario based on entry information of an emoji button, wherein the entry information comprises at least one of a position or an identifier of the emoji button in the service scenario.

20. The electronic device according to claim 13, wherein the current service scenario is a service scenario of cloud document or a service scenario of video conference.

21. The electronic device according to claim 13, wherein the processor is further configured to:
receive a custom emoji uploaded by an administrator; and
update emoji panels corresponding to all users within an organization to which the administrator belongs based on the custom emoji and the organization.

22. The electronic device according to claim 21, wherein the processor is further configured to:
obtain target application scenario(s) for the custom emoji; and
update the emoji panel corresponding to the target application scenario(s) of the all users within the organization to which the administrator belongs based on the custom emoji and the organization.
